(19) United States
(12) Patent Application Publication
(10) Pub. No.: US 2015/0355868 A1
(43) Pub. Date: Dec. 10, 2015

(54) IMAGE FORMING APPARATUS AND IMAGE FORMING METHOD

(71) Applicants: KABUSHIKI KAISHA TOSHIBA, Tokyo (JP); TOSHIBA TEC KABUSHIKI KAISHA, Tokyo (JP)

(72) Inventor: Yayoi Doi, Mishima-shi (JP)

(21) Appl. No.: 14/296,696

(22) Filed: Jun. 5, 2014

(51) Int. Cl. G06F 3/12

(52) U.S. Cl. CPC G06F 3/1219; G06F 3/1242

(57) ABSTRACT

An image forming apparatus comprises an acquisition section configured to acquire a surface image from a document; a printing section configured to carry out printing on both sides of paper; and a control section configured to acquire a first surface image and a second surface image through the acquisition section, extract a high concentration area from the first surface image, extract a wide area from the second surface image, extract a replacement area that overlaps with the high concentration area from the wide area in a case of respectively printing the first surface image and the second surface image on both sides of the paper, replace the replacement area with a pattern which consumes less printing material, and respectively print the first surface image and the second surface image in which the replacement area is replaced with the pattern on both sides of the paper using the printing section.

### FIELD

Embodiments described herein relate to an image forming apparatus and an image forming method.

### BACKGROUND

An image forming apparatus forms an image with an image forming material such as toner or ink. In the image forming apparatuses, there is an image forming apparatuses which reduces the printing concentration of an image such as characters so as to save the image forming material. However, conventionally, there is a problem that the visibility of the printed image is reduced if the image forming apparatus reduces the printing concentration.

### BRIEF DESCRIPTION OF THE DRAWINGS

FIG. 1 is a diagram illustrating an example of a cross-sectional view of an image forming apparatus according to an embodiment;

FIG. 2 is a block diagram illustrating an example of the constitution of the image forming apparatus according to the embodiment;

FIG. 3 is a block diagram illustrating an example of the constitution of a scanner according to the embodiment;

FIG. 4 is a block diagram illustrating an example of the constitution of an operation panel according to the embodiment;

FIG. 5 is a diagram illustrating an example of a wide area according to the embodiment;

FIG. 6 is a diagram illustrating an example of an internal area according to the embodiment;

FIG. 7 is a diagram illustrating an example of a high concentration area and a replacement area according to the embodiment;

FIG. 8 is a diagram illustrating an example of a pattern according to the embodiment;

FIG. 9 is a diagram illustrating another example of a pattern according to the embodiment;

FIG. 10 is a diagram illustrating an example of a document surface according to the embodiment;

FIG. 11 is a diagram illustrating another example of a document surface according to the embodiment;

FIG. 12 is a diagram illustrating an example of a printing surface according to the embodiment;

FIG. 13 is a diagram illustrating another example of a printing surface according to the embodiment;

FIG. 14 is a flowchart illustrating an example of the operations of the image forming apparatus according to the embodiment;

FIG. 15 is a flowchart illustrating an example of the operations of the image forming apparatus according to the embodiment;

FIG. 16 is a flowchart illustrating another example of the operations of the image forming apparatus according to the embodiment; and

FIG. 17 is a flowchart illustrating another example of the operations of the image forming apparatus according to the embodiment.

### DETAILED DESCRIPTION

In accordance with one embodiment, an image forming apparatus comprises an acquisition section, a printing section and a control section. The acquisition section acquires a surface image from a document. The printing section carries out printing on both sides of paper. The control section acquires a first surface image and a second surface image through the acquisition section, extracts a high concentration area from the acquired first surface image, extracts a wide area from the acquired second surface image, extracts a replacement area that overlaps with the high concentration area from the extracted wide area in a case of respectively printing the first surface image and the second surface image on both sides of the paper, replaces the extracted replacement area with a pattern which consumes less printing material, and respectively prints the acquired first surface image and the second surface image in which the replacement area is replaced with the pattern on the both sides of the paper using the printing section.

### A First Embodiment

The embodiment is described below with reference to the accompanying drawings.

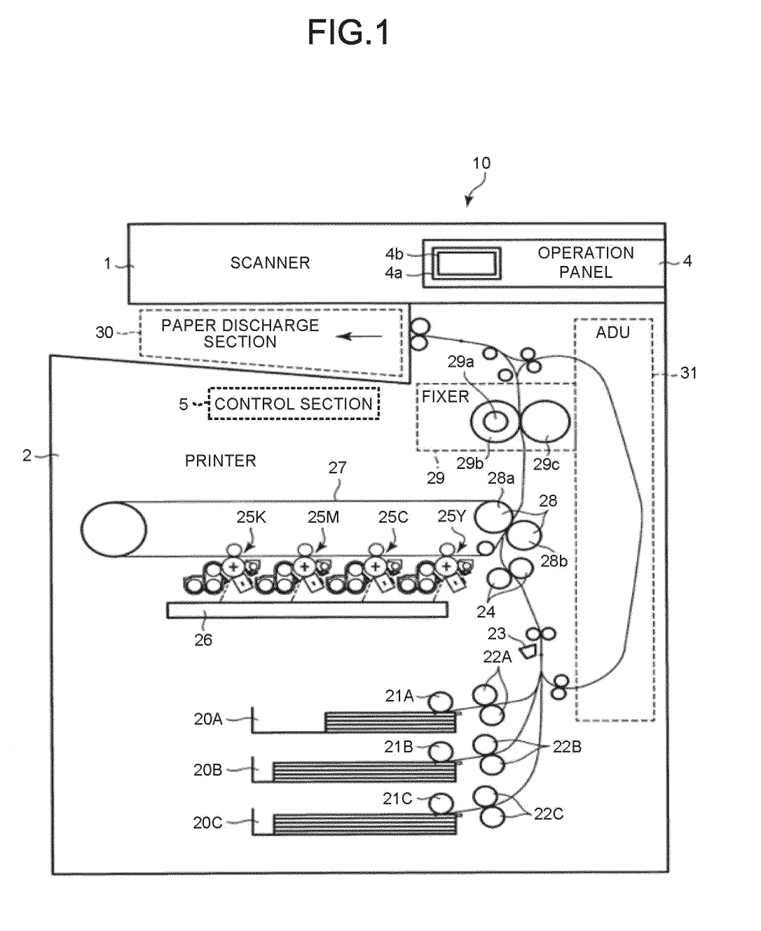

FIG. 1 is a cross-sectional view schematically illustrating an example of the constitution of a digital multi-functional peripheral 10 according to the embodiment.

The digital multi-functional peripheral (MFP) 10 according to the present embodiment functions as an image forming apparatus. As shown in FIG. 1, the digital multi-functional peripheral 10 (image forming apparatus) comprises a scanner 1, a printer 2, an operation panel 4 and a control section 5.

The scanner 1 (acquisition section) reads an image on a document and converts it into image data. The scanner 1 is composed of a CCD line sensor and the like for converting, for example, the image on the reading surface of the document into image data. Further, the scanner 1 has a function (document detection function) of detecting the size of the document. The scanner 1 is arranged at, for example, the upper portion of the main body of the digital multi-functional peripheral 10. The scanner 1 is controlled by the control section 5. The scanner 1 outputs the image data of the document to the control section 5.

The printer 2 (printing section) forms an image on paper serving as an image formed medium. The printer 2 serving as an image forming apparatus has a color printing function of printing a color image on paper and a monochrome printing function of printing a monochrome (for example, black) image on paper. For example, the printer 2 is an electrophotographic type image forming apparatus. The printer 2 forms a color image using toner (printing material) of a plurality of colors (for example, three colors of yellow (Y), cyan (C) and magenta (M)). Further, the printer 2 forms a monochrome image using monochrome (for example, black) toner. The printer 2 is not limited to the electrophotographic type image forming apparatus as long as the printer 2 is a printer including the color printing function and the monochrome printing function. For example, the printer 2 may be an inkjet type image forming apparatus, or a thermal transfer type image forming apparatus.

In the constitution example shown in FIG. 1, the printer 2 includes paper feed cassettes 20 (20A, 20B and 20C) which serve as paper feed sections for feeding paper on which an image is to be printed. Further, the printer 2 may also include a manual feeding tray and the like as a paper feed section. For example, each paper feed cassette 20A, 20B and 20C is arranged at the lower portion of the main body of the digital multi-functional peripheral 10 in a detachable manner. These paper feed cassettes 20A, 20B and 20C respectively store paper of a set category (for example, size and quality).

Setting information such as the information relating to the paper stored in each paper feed cassette is stored in a non-volatile memory (for example, a NVM 54 described later). The printer 2 selects the paper feed cassette in which the paper to be used in printing processing is stored according to the setting information. The printer 2 prints an image on the paper fed from the selected paper feed cassette. In addition, in a case where the printer 2 includes a manual feeding tray, like each paper feed cassette, the setting information relating to the paper stored in the manual feeding tray may also be stored in the non-volatile memory.

Each paper feed cassette 20A, 20B and 20C is provided with a pickup roller 21A, 21B and 21C, respectively. The pickup rollers 21A, 21B and 21C pick up paper one by one from each paper feed cassette 20A, 20B and 20C. The pickup rollers 21A, 21B and 21C feed the picked up paper to a conveyance section 22 provided with a plurality of conveyance rollers and the like. The number of the paper feed cassettes serving as paper feed sections and the number of the pickup rollers are not limited to three. For example, the number of the paper feed cassettes and the number of the pickup rollers may be one, two, four or more. Further, the paper feed section is not limited to a cassette, and it may also be a manual feeding tray.

The conveyance section 22 conveys paper in the printer 2. The conveyance section 22 conveys the paper fed by the pickup rollers 21A, 21B and 21C to a register roller 24. The register roller 24 conveys the paper to a transfer position at the timing of transferring an image to the paper from an intermediate transfer belt 27.

Image forming sections 25 (25Y, 25M, 25C and 25K), an exposure section 26, the intermediate transfer belt 27 and a transfer section 28 function as an image forming module for forming an image. The image forming sections 25 (25Y, 25M, 25C and 25K) form an image which is to be transferred to the paper. In the constitution example shown in FIG. 1, the image forming section 25Y forms an image with yellow toner. The image forming section 25M forms an image with magenta toner. The image forming section 25C forms an image with cyan toner. The image forming section 25K forms an image with black toner. Each image forming section 25 (25Y, 25M, 25C and 25K) superimposes and transfers the image of each color to the intermediate transfer belt 27. In this way, a color image is formed on the intermediate transfer belt 27.

The exposure section 26 forms an electrostatic latent image on a photoconductive drum (image carrier) of each image forming section 25 (25Y, 25M, 25C and 25K) through laser light. The exposure section 26 irradiates the photoconductive drum with laser light controlled according to the image data through an optical system such as a polygon mirror and the like. The laser light from the exposure section 26 forms an electrostatic latent image on the surface of each photoconductive drum. The exposure section 26 controls the laser light according to a control signal from the control section 5. The electrostatic latent image formed on each photoconductive drum is an image to be developed with the toner of each color. For example, the exposure section 26 controls the power of the laser light according to the control signal from the control section 5. Further, the exposure section 26 controls, for example, the modulation quantity of pulse width for controlling the emitting of the laser light according to the control signal from the control section 5.

Each image forming section 25 (25Y, 25M, 25C and 25K) develops the electrostatic latent image formed on the photoconductive drums thereof with the toner of each color. Each image forming section 25 (25Y, 25M, 25C and 25K) forms a toner image serving as a visible image on the photoconductive drum. The intermediate transfer belt 27 is an intermediate transfer body. Each image forming section (25Y, 25M, 25C and 25K) transfers (primarily transfer) the toner image formed on the photoconductive drum to the intermediate transfer belt 27. Each image forming section 25 (25Y, 25M, 25C and 25K) applies a transfer bias to the toner image at a primary transfer position. Each image forming section 25 (25Y, 25M, 25C and 25K) controls the transfer bias through transfer current. The toner image on each photoconductive drum is transferred to the intermediate transfer belt 27 through the transfer bias at the primary transfer position thereof. The control section 5 controls the transfer current which is used by each image forming section in the primary transfer processing.

Further, each image forming section 25Y, 25M, 25C and 25K has a sensor such as a potential sensor, a concentration sensor and the like, respectively. The potential sensor is a sensor for detecting the surface potential of the photoconductive drum. In each image forming section 25Y, 25M, 25C and 25K, a charging charger charges the surface of the photoconductive drum before it is exposed by the exposure section 26. The control section 5 can change the charging condition based on the charging charger. The potential sensor detects the surface potential of the photoconductive drum the surface of which is charged by the charging charger. The concentration sensor detects the concentration of the toner image transferred to the intermediate transfer belt 27. Further, the concentration sensor may also be a sensor detecting the concentration of the toner image formed on the photoconductive drum.

For example, in a case of forming a monochrome image, the image forming section 25K transfers (primarily transfer) the toner image (visible image) developed with the black (monochrome) toner to the intermediate transfer belt 27. As a result, the intermediate transfer belt 27 holds a monochrome image formed with the black (monochrome) toner.

Further, in a case of forming a color image, each image forming section 25Y, 25M, 25C and 25K superimposes and transfers (primarily transfer) the toner image (visible image) developed with the toner of each color (yellow, magenta, cyan and black) to the intermediate transfer belt 27. As a result, the intermediate transfer belt 27 holds a color image obtained by overlapping the toner image of each color.

The transfer section 28 transfers the toner image on the intermediate transfer belt 27 to the paper at a secondary transfer position. The secondary transfer position is a position where the toner image on the intermediate transfer belt 27 is transferred to the paper. The secondary transfer position is a position where a support roller 28a and secondary transfer roller 28b are opposed. The transfer section 28 applies a transfer bias which is controlled through transfer current at the secondary transfer position. The transfer section 28 transfers the toner image (color erasable toner image or general toner image) on the intermediate transfer belt 27 to the paper through the transfer bias. The control section controls the transfer current which is used in a secondary transfer processing. For example, the control section 5 may respectively control the transfer current used in a case of transferring the color erasable toner image and the transfer current used in a case of transferring the general toner image.

A fixer 29 has a function of fixing the toner on the paper. For example, in the embodiment, the fixer 29 fixes the toner image on the paper through heat applied to the paper. However, the fixer 29 is not limited to a fixer which fixes an image by heating as long as the fixer 29 can fix an image on paper.

The fixer 29 has a constitution of applying heat to paper for carrying out a fixing processing. In the constitution example shown in FIG. 1, the fixer 29 consists of a heating roller 29b in which a heating section 29a is arranged and a pressing roller 29c which contacts with the fixing belt heated by the heating roller 29b in pressure. The heating section 29a may be a temperature controllable heater. For example, the heating section 29a may be a heater consisting of a heater lamp such as a halogen lamp and the like, or an induction heating (IH) heater. Further, the heating section 29a may also consist of a plurality of heaters.

For example, in a case of carrying out fixing processing of fixing the toner image on the paper, the control section 5 controls the fixer 29 to the fixing temperature. The fixer 29 controlled to the fixing temperature presses and heats the paper to which the toner image is transferred by the transfer section 28 at the fixing temperature. In this way, the fixer 29 fixes the toner image on the paper. Further, the fixer 29 conveys the paper subjected to fixing processing to a paper discharge section 30 or an automatic double-sided unit (ADU) 31.

In a case of discharging the paper subjected to the fixing processing by the fixer 29, the paper is conveyed to the paper discharge section 30. Further, in a case of forming an image on the back side of the paper subjected to the fixing processing by the fixer 29, the paper is temporarily conveyed towards the paper discharge section 30, and then switched back and conveyed to the ADU 31. In this case, the ADU 31 feeds the paper which is inverted through the switch-back to the register roller 24 again.

The operation panel (operation section) 4 is a user interface. The operation panel 4 comprises a display section 4a which includes various buttons and a touch panel 4b. The control section 5 controls the content to be displayed on the display section 4a of the operation panel 4. Further, the operation panel 4 outputs information input through the touch panel 4b or the buttons of the display section 4a to the control section 5. A user designates an operation mode, or inputs information such as machine setting information and the like in the operation panel 4. For example, the user designates the category of the paper stored in the paper feed cassette 20 through the operation panel 4.

Next, the constitution of a control system of the digital multi-functional peripheral 10 is described.

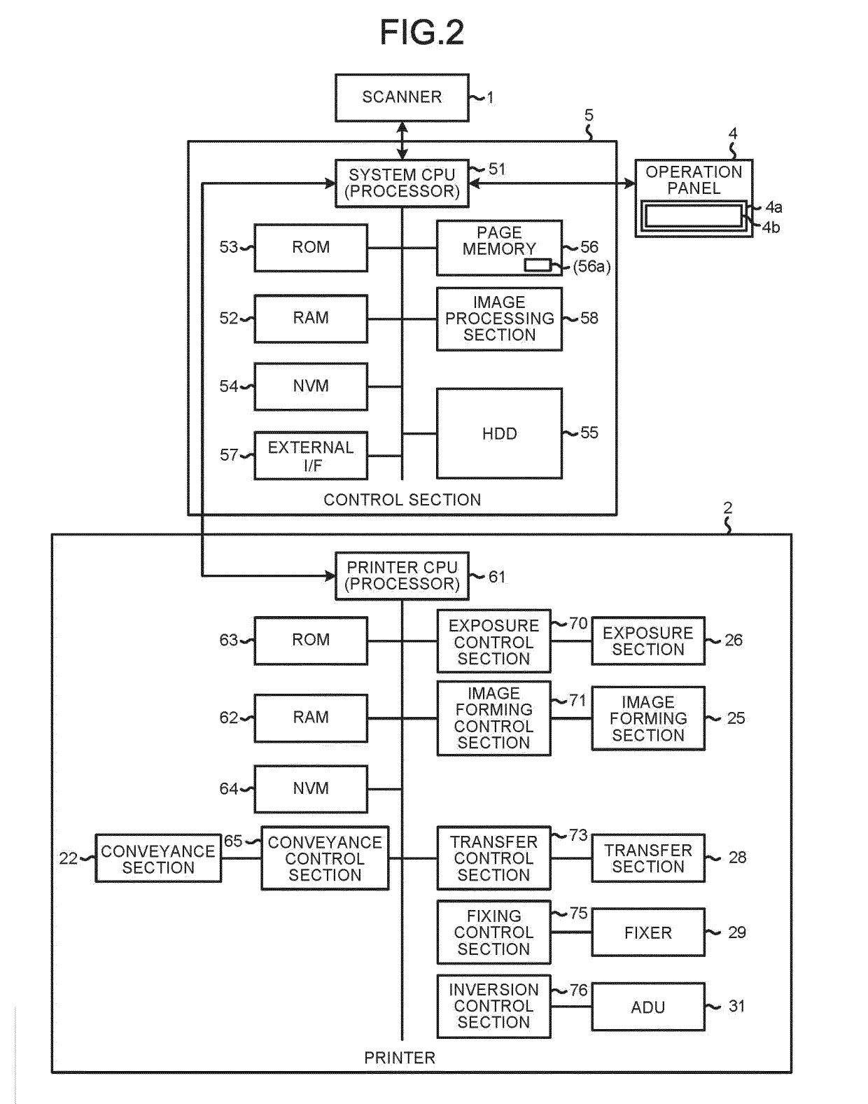

FIG. 2 is a block diagram schematically illustrating an example of the constitution of the control system in the control section 5 and the printer 2 of the digital multi-functional peripheral 10.

In the constitution example shown in FIG. 2, the control section 5 comprises a system CPU 51 (processor), a RAM 52, a ROM 53, a NVM 54, a HDD 55, a page memory 56, an external interface 57 (external I/F) and an image processing section 58.

The system CPU 51 uniformly controls the whole digital multi-functional peripheral 10 and each section. The system CPU 51, which is a processor realizing processing by executing a program, is connected with each section of the control section 5 through a system bus line. In addition to each section of the control section 5, the system CPU 51 is also connected with the scanner 1, the printer 2, the operation panel 4 and the like through the system bus line. The system CPU 51 outputs an operation instruction to each section and acquires various kinds of information from each section through a two-way communication with the scanner 1, the printer 2 and the operation panel 4. Further, the system CPU 51 inputs information indicating detection signals of various sensors arranged in each section of the control section 5, an operation state and the like.

The RAM 52 consists of a volatile memory. The RAM 52 functions as a working memory or a buffer memory. The ROM 53 is an unrewritable non-volatile memory for storing a program, control data and the like. The system CPU 51 realizes various processing by executing the program stored in the ROM 53 (or the NVM 54 or the HDD 55) while using the RAM 52. For example, the system CPU 51 functions as a printing execution module and a printing forbidden module by executing the program.

The NVM 54 is a rewritable non-volatile memory which stores the control program executed by the system CPU 51 and the control data. Further, NVM 54 stores various kinds of setting information, processing conditions and the like. For example, the NVM 54 stores the setting information for each paper feed cassette (paper feed section).

The hard disk drive (HDD) 55 is a high-capacity storage device. The HDD 55 stores the image data, various kinds of operation history information and the like. Further, the HDD 55 may also store the control program, the control data and the like, or the setting information, the processing condition and the like.

The page memory 56 is a memory for expanding the image data to be processed. For example, in case of carrying out copy processing, the page memory 56 stores the image data which is read by the scanner 1 and is subjected to the image processing for scanning. The system CPU 51 carries out the image processing for printing on the image data stored in the page memory 56, and outputs the printing data to the printer 2. Further, the system CPU 51 stores the image data stored in the page memory 56 in the HDD 55, and sends the image data to an external device through the external interface 57.

The external interface 57 (external I/F) is an interface for communicating with the external device. For example, the external interface 57 receives printing data corresponding to a print request from the external device. The external interface 57 may be an interface for carrying out data notification with the external device; for example, the external interface 57 may be an interface locally connected with the external device, or a network interface for communicating through a network.

The image processing section 58 has a function of an image processing section of a scanner system for carrying out an image processing on the image data read by the scanner 1, a compression and expansion section for carrying out compression or expansion processing on the image data, and an image processing section of a printer system for generating the image data for printing to be printed by the printer 2 on paper. For example, as the image processing section of a scanner system, the image processing section has functions such as shading correction processing, gradation conversion processing, interline correction processing and the like.

In addition, the control section 5 may consist of a plurality of control sections. Further, the processing carried out by the control section 5 may be carried out by the plurality of control sections constituting the control section 5, respectively.

Next, an example of the constitution of the control system in the printer 2 is described.

In the constitution example shown in FIG. 2, the printer 2 comprises, as the constitution of the control system, a printer CPU 61 (processor), a RAM 62, a ROM 63, a NVM 64, a conveyance control section 65, an exposure control section 70, an image forming control section 71, a transfer control section 73, a fixing control section 75, an inversion control section 76 and the like.

The printer CPU 61 controls the whole printer 2. The printer CPU 61, which is a processor realizing processing by executing a program, is connected with each section of the printer 2 through a system bus line and the like. The printer CPU 61 outputs, in response to the operation instruction from the system CPU 51, an operation instruction to each section of the printer 2, and notifies various kinds of information acquired from each section to the system CPU 51.

The RAM 62 consists of a volatile memory. The RAM 62 functions as a working memory or a buffer memory. The ROM is an unrewritable non-volatile memory for storing a program, control data and the like. The printer CPU 61 realizes various processing by executing the program stored in the ROM 63 (or the NVM 64) while using the RAM 62.

The NVM 64 is a rewritable non-volatile memory which stores, for example, the control program executed by the printer CPU 61 and the control data. Further, the NVM 64 stores the setting information, processing conditions and the like.

The conveyance control section 65 controls the paper conveyance in the printer 2 and the driving of the pickup roller 21 and the conveyance section 22. The conveyance control section 65 controls the driving of the conveyance rollers serving as the conveyance section 22 in the printer 2 in response to the operation instruction from the printer CPU 61. For example, the printer CPU 61 instructs, in response to an instruction of starting image erasing processing or image forming processing from the control section 5, the conveyance control section 65 to start to feed a paper with the pickup roller 21 and the conveyance section 22.

The exposure control section 70 controls the exposure section 26. The exposure control section 70 forms an electrostatic latent image on the photoconductive drum of each image forming section 25Y, 25M, 25C and 25K using the exposure section 26 in response to the operation instruction from the printer CPU 61. For example, the exposure control section 70 controls, in response to the image data instructed by the printer CPU 61, the laser light emitted by the exposure section 26 to each photoconductive drum

The image forming control section 71 controls the driving of each image forming section 25Y, 25M, 25C and 25K. The image forming control section 71 develops, in response to the operation instruction from the printer CPU 61, the electrostatic latent image formed on the photoconductive drum of each image forming section 25Y, 25M, 25C and 25K with toner of each color. The transfer control section 73 controls the driving of the transfer section 28 and the transfer current and the like. The transfer control section 73 transfers, in response to the operation instruction from the printer CPU 61, the toner image transferred to the intermediate transfer belt 27 to the paper using the transfer section 28.

The fixing control section 75 controls the driving of the fixer 29. The fixing control section 75 drives the heating roller 29b and the pressing roller 29c in response to the operation instruction from the printer CPU 61. Further, the fixing control section 75 controls the surface temperature of the heating roller 29b to a desired temperature by controlling the heating section 29a. The fixing control section 75 controls the surface temperature of the heating roller 29b to a temperature (fixing temperature) designated by the printer CPU 61.

The inversion control section 76 controls the driving of the ADU 31. The inversion control section 76 feeds, in response to the operation instruction from the printer CPU 61, the paper passing through the fixer 29 to an image reading position of the scanner 23 again using the ADU 31. For example, in a case of forming an image on the back side of the paper subjected to the fixing processing (in a case of duplex printing), the inversion control section 76 carries out a driving control such that the paper subjected to the fixing processing is temporarily conveyed towards the paper discharge section 30, and then switched back to be conveyed to the ADU 31. The ADU 31 feeds the paper switched back by the paper discharge section 30 to the register roller 24 again. In this way, the paper is fed to the register roller 24 again in an inverted state.

Next, the scanner 1 is described.

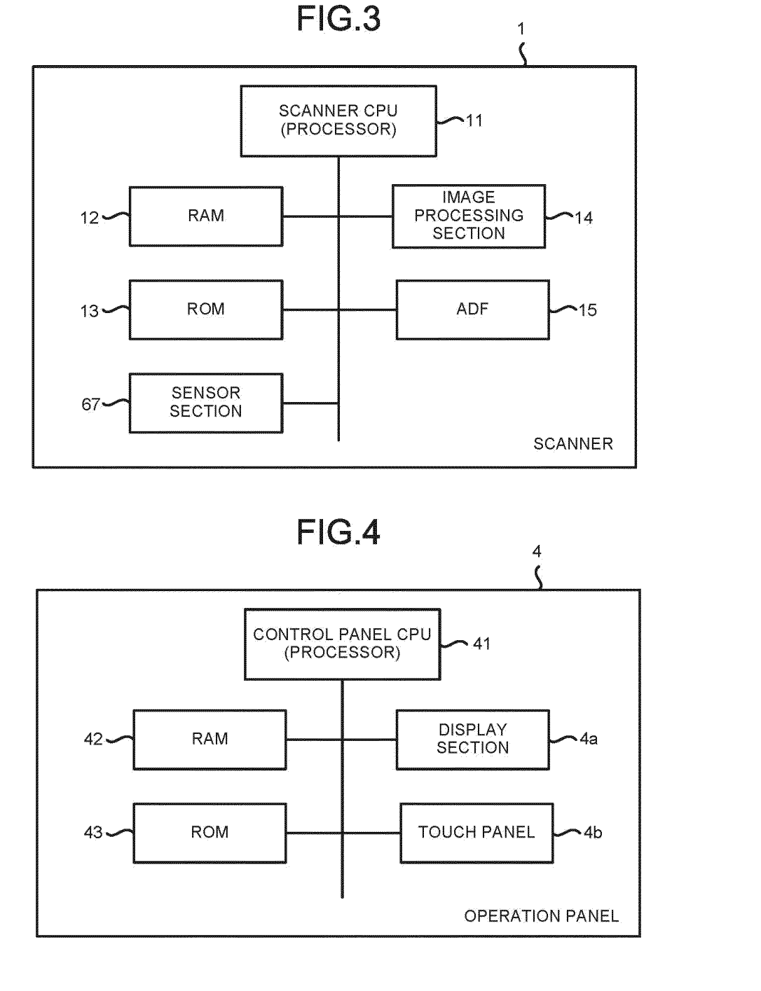

FIG. 3 is a block diagram illustrating an example of the constitution of the scanner 1.

As shown in FIG. 3, the scanner 1 comprises a scanner CPU 11 (processor), a RAM 12, a ROM 13, an image processing section 14, an ADF 15, a sensor section 67 and the like.

The scanner CPU 11 controls the whole scanner 1. The scanner CPU 11 reads the image on the paper according to the operation instruction from the system CPU 51 and the like. For example, the scanner CPU 11 reads the image on the paper detected by the sensor section 67 at an image reading position. Further, the scanner CPU 11 transfers the image data read by the sensor section 67 to the control section 5. The control section 5 transfers the image data of the paper read by the scanner 1 to the image processing section 58 and stores the data in the HDD 55 and the like after a proper image processing is carried out.

The RAM 12 consists of a volatile memory. The RAM 12 functions as a working memory or a buffer memory. The ROM 13 is an unrewritable non-volatile memory for storing a program, control data and the like. The scanner CPU 11 realizes various processing by executing the program stored in the ROM 13 while using the RAM 12.

The image processing section 14 processes the image data read by the sensor section 67 so that the image data becomes proper image data. For example, the image processing section 14 carries out image processing such as a skew processing or size correction and the like on the image data. The image processing section 14 realizes the function of the scanner CPU 11.

The ADF 15 automatically feeds the paper set in the scanner 1.

The sensor section 67 is a sensor for reading the paper set in the scanner 1. For example, the sensor section 67 is a CCD line sensor and the like.

The sensor section 67 can simultaneously read the front and back surface of the document. For example, the sensor section 67 includes two CCD line sensors that face each other. The scanner CPU 11 passes the document through the two CCD line sensors to simultaneously read the front and back surface of the document. That is, the scanner 1 can simultaneously read the front and back surface of the document.

In addition, the scanner CPU 11 may also realize the function of the system CPU 51.

Next, the operation panel 4 is described.

FIG. 4 is a block diagram illustrating an example of the constitution of the operation panel 4.

As shown in FIG. 4, the operation panel 4 comprises a display section 4a, a touch panel 4b, a control panel CPU 41 (processor), a RAM 42, a ROM 43 and the like.

The control panel CPU 41 controls the whole operation panel 4. For example, the control panel CPU 41 displays an icon and the like for a user to input an operation on the display section 4a. Further, the control panel CPU 41 acquires the operation input in the touch panel 4b. The control panel CPU 41 sends the input operation to the system CPU 51 and the like.

The RAM 42 consists of a volatile memory. The RAM 62 functions as a working memory or a buffer memory. The ROM is an unrewritable non-volatile memory for storing a program, control data and the like. The control panel CPU realizes various processing by executing the program stored in the ROM 43 while using the RAM 42.

In addition, the control panel CPU 41 may realize the function of the system CPU 51.

Next, the function realized by the image processing section 58 is described.

The image processing section 58 has a function of extracting a high concentration area from the document surface scanned by the scanner 1. The high concentration area refers to an area where print-through occurs and the printed data can be seen from the back surface. That is, the back surface of the high concentration area looks black due to the print-through of the high concentration area.

For example, the high concentration area is an area where the concentration of pixels exceeds a given threshold value. The image processing section 58 compares the concentration of pixels at each point of the document surface with the given threshold value and extracts the high concentration area.

Further, the image processing section 58 has a function of extracting a wide area from the document surface scanned by the scanner 1. The wide area refers to an area where the width of a printing area (area where there are dots) is greater than a given threshold value. That is, even if one part inside the wide area is replaced with a pattern, there is almost no impact on the visibility.

The image processing section 58 extracts a wide area through image area identification. For example, the image processing section 58 extracts the wide area by carrying out line segment detection, macro segmentation, or micro segmentation and the like as the image area identification. No specific limitation is given to the method of extracting the wide area by the image processing section 58.

In addition, the image processing section 58 may extract a character or one part of a character as the wide area. For example, the image processing section 58 extracts a character area through the image area identification. The image processing section 58 extracts the wide area from the extracted character area.

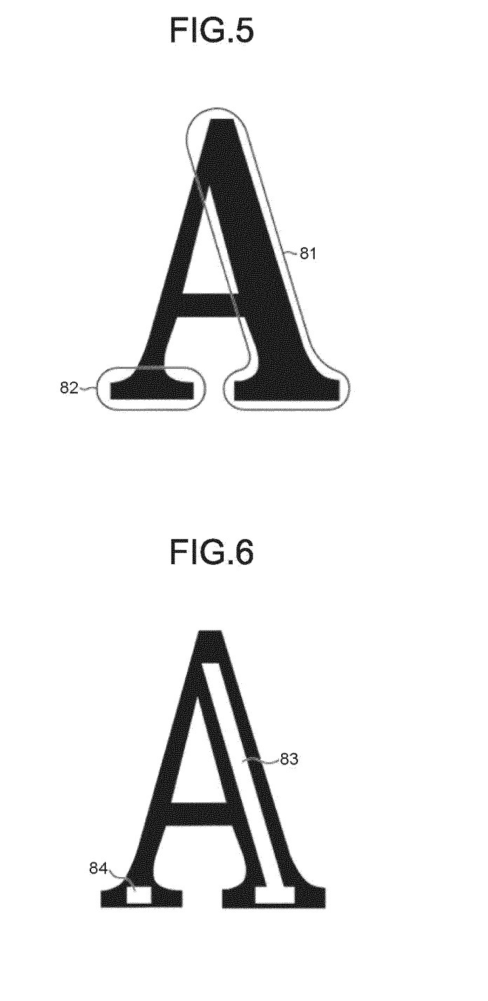

FIG. 5 is a diagram illustrating an example of the wide area extracted by the image processing section 58.

In the example shown in FIG. 5, the image processing section 58 extracts the wide area shown by an area 81 and the wide area shown by an area 82.

The wide areas refer to the printed areas in the area 81 and the area 82.

As shown in FIG. 5, the wide areas refer to areas where the width of the printed area exceeds the given threshold value.

In addition, no specific limitation is given to the threshold value of the width of the printed area.

Further, the image processing section 58 has a function of extracting the internal area excluding the contour of the wide area from the wide area. For example, the image processing section 58 extracts, as the contour, an area between the outer frame of the wide area and the line which is inside the wide area and is at a given distance from the outer frame of the wide area. The image processing section extracts the internal area excluding the extracted contour from the wide area. No specific limitation is given to the method of extracting the internal area by the image processing section 58.

FIG. 6 is a diagram illustrating an example of the internal area extracted by the image processing section 58.

In the example shown in FIG. 6, the image processing section 58 extracts an internal area 83 and an internal area 84.

The internal area 83 is the internal area corresponding to the wide area shown by the area 81. The internal area 84 is the internal area corresponding to the wide area shown by the area 82.

As shown in FIG. 6, the internal area is an area inside the wide area excluding the contour of the wide area. That is, the internal area is an area inside the wide area.

In addition, No specific limitation is given to the value of the width of the contour.

Further, in a case of carrying out printing on both sides of the paper, the image processing section 58 has a function of extracting an area that overlaps with the high concentration area of the back surface from the internal area as a replacement area. That is, in a case of printing the front document surface and the back document surface on the paper, the image processing section 58 extracts the replacement area where the internal area of the front surface overlaps with the high concentration area of the back surface.

The replacement area is an area where print-through occurs and the printed data of the back surface can be seen due to the high concentration area of the back surface. Thus, the visibility of the printed data is less likely to lower even if the replacement area is replaced with a pattern with gaps.

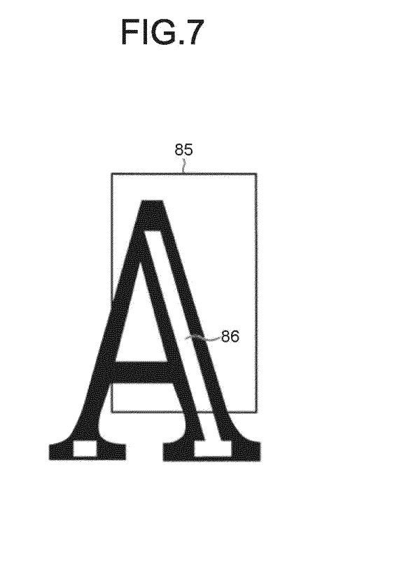

FIG. 7 is a diagram illustrating an example of the replacement area extracted by the image processing section 58.

FIG. 7 illustrates a high concentration area 85 of the back surface and a replacement area 86.

The high concentration area 85 looks black due to the print-through of the back surface.

As shown in FIG. 7, the image processing section 58 extracts the replacement area 86. The replacement area 86 is an area where the internal area 83 overlaps with the high concentration area 85. A lower area 83a of the internal area 83, which does not overlap with the high concentration area 85, is not extracted as the replacement area.

Further, as the entire internal area 84 does not overlap with the high concentration area 85, no part of the internal area 84 is extracted as the replacement area.

The image processing section 58 has a function of replacing the replacement area with a pattern. That is, the image processing section 58 replaces the replacement area with a pattern which can reduce the consumption of the printing material. For example, the pattern is a diagonal line pattern, a vertical line pattern, a horizontal line pattern, a cross hatch pattern, a dot pattern or a white blank pattern. The image processing section 58 replaces the replacement area with the diagonal line pattern, vertical line pattern, horizontal line pattern, cross hatch pattern, dot pattern or white blank pattern.

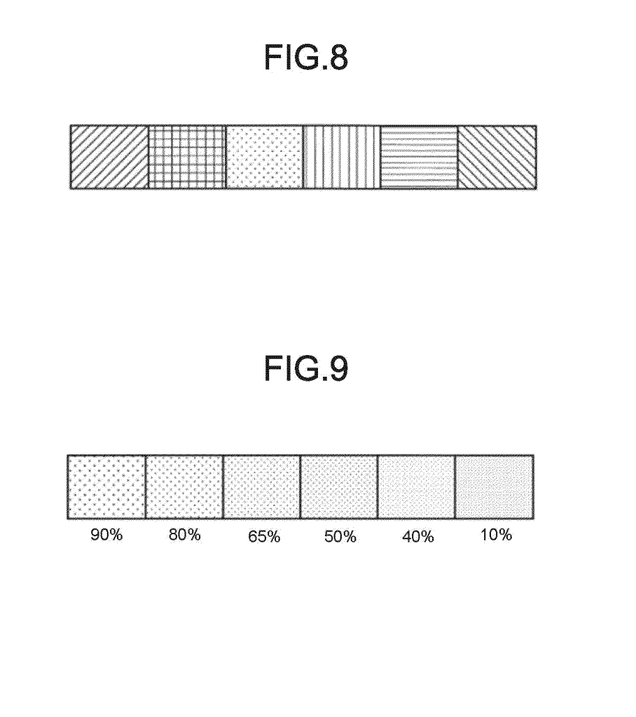

FIG. 8 is a diagram illustrating an example of the pattern with which the image processing section 58 replaces the replacement area.

As shown in FIG. 8, the pattern with which the image processing section 58 replaces the replacement area is a rising diagonal line pattern, cross hatch pattern, dot pattern, vertical line pattern, horizontal line pattern or falling diagonal line pattern and the like.

In addition, the image processing section 58 may replace the replacement area with other patterns. No specific limitation is given to the constitution of the pattern with which the system CPU 51 replaces the replacement area.

The image processing section 58 selects one pattern from a plurality of patterns, and replaces the replacement area with the selected pattern.

The image processing section 58 may also select a pattern according to an instruction of a user of the digital multi-functional peripheral 10. For example, the control panel CPU 41 may display a plurality of patterns on the display section 4a, and the system CPU 51 may receive an operation of selecting a pattern through the touch panel 4b. Further, in a case where there is no selection from the user, the image processing section 58 may select a recommended pattern.

The control panel CPU 41 may also display a percentage of the saved toner as well as the pattern on the display section 4a, and the system CPU 51 receives the selection of pattern.

FIG. 9 is a diagram illustrating an example in which patterns are arranged according to the percentage of the saved toner.

FIG. 9 illustrates a pattern which can save 90% toner, a pattern which can save 80% toner, a pattern which can save 65% toner, a pattern which can save 50% toner, a pattern which can save 40% toner and a pattern which can save 10% toner.

The toner saving ratio is a percentage of the difference between the quantity of toner required to print a certain area to be black and the quantity of toner required to print the same area in a pattern. For example, if the toner saving ratio is 90%, the quantity of toner required to print a certain area in a pattern is 10% (100%−90%) of the quantity of toner required to print the same area to be black.

That is, the higher the toner saving ratio of a pattern is, the more the quantity of the saved toner is. On the other hand, the higher the toner saving ratio of a pattern is, the lower the concentration of the replacement area is, which leads to a low visibility.

The control panel CPU 41 may display both the pattern and the toner saving ratio of the pattern on the display section 4a, and the system CPU 51 may receive a selection of pattern from the user through the touch panel 4b. Further, in a case where there is no selection from the user, the system CPU 51 may select a recommended pattern.

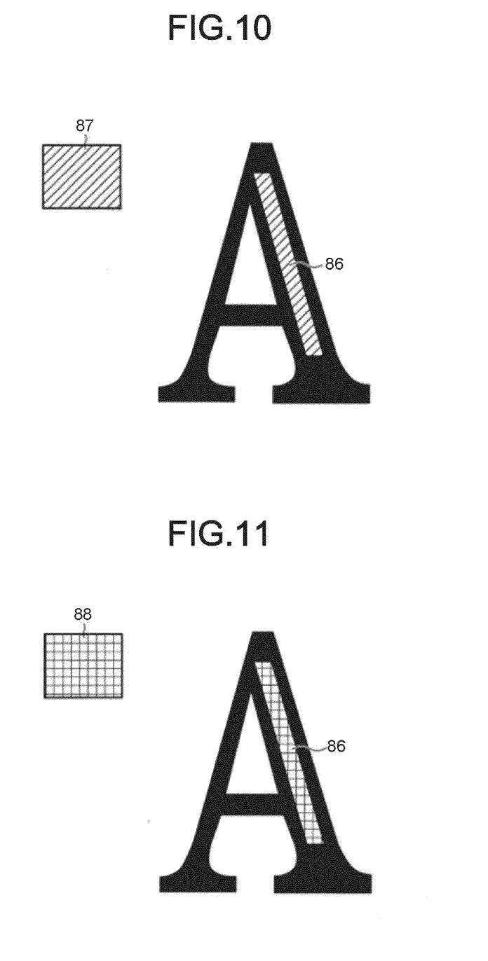

FIG. 10 is a diagram illustrating an example of a document surface on which the image processing section 58 replaced the replacement area with a pattern.

In the example shown in FIG. 10, the image processing section 58 selects a rising diagonal line pattern 87. For example, the system CPU 51 receives an operation of selecting the rising diagonal line pattern 87 from the user. Alternatively, the image processing section 58 sets the rising diagonal line pattern 87 as the recommended pattern.

As shown in FIG. 10, the replacement area 86 is replaced with the rising diagonal line pattern 87.

FIG. 11 is a diagram illustrating an example of a document surface on which the image processing section 58 replaced the replacement area with another pattern.

In the example shown in FIG. 11, the image processing section 58 selects a cross hatch pattern 88. For example, the system CPU 51 receives an operation of selecting the cross hatch pattern 88 from the user.

As shown in FIG. 11, the replacement area 86 is replaced with the cross hatch pattern 88.

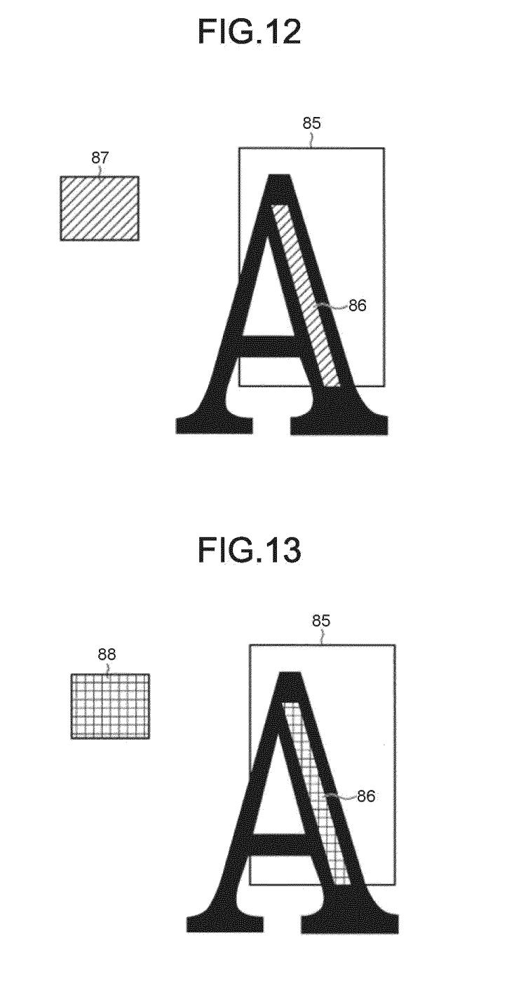

FIG. 12 is a diagram illustrating an example of a printing surface where the document surface, of which the replacement area is replaced with a pattern by the image processing section 58, is printed.

FIG. 12 illustrates an example of a printing surface in a case where the image processing section 58 replaces the replacement area 86 with the rising diagonal line pattern 87 shown in FIG. 10.

As shown in FIG. 12, the replacement area 86 which is replaced by the image processing section 58 with the rising diagonal line pattern 87 is an area of which the back surface is a high concentration area. Thus, the part (that is, gaps of the pattern) inside the replacement area 86 where no printing is carried out becomes inconspicuous due to the print-through of the back surface.

FIG. 13 is a diagram illustrating another example of a printing surface where the document surface, of which the replacement area is replaced with a pattern by the image processing section 58, is printed.

FIG. 13 illustrates an example of a printing surface in a case where the image processing section 58 replaces the replacement area 86 with the cross hatch pattern 88 shown in FIG. 11.

As shown in FIG. 13, the replacement area 86 which is replaced by the image processing section 58 with the cross hatch pattern 88 is an area of which the back surface is a high concentration area. Thus, similar to the example shown in FIG. 12, the part (that is, gaps of the pattern) inside the replacement area 86 where no printing is carried out becomes inconspicuous due to the print-through of the back surface.

The system CPU 51 executes the program on the RAM 52 and applies settings to the image processing section 58 to realize each function described above. The program may be stored in the NVM 54.

Next, an example of the operations of the digital multi-functional peripheral 10 is described.

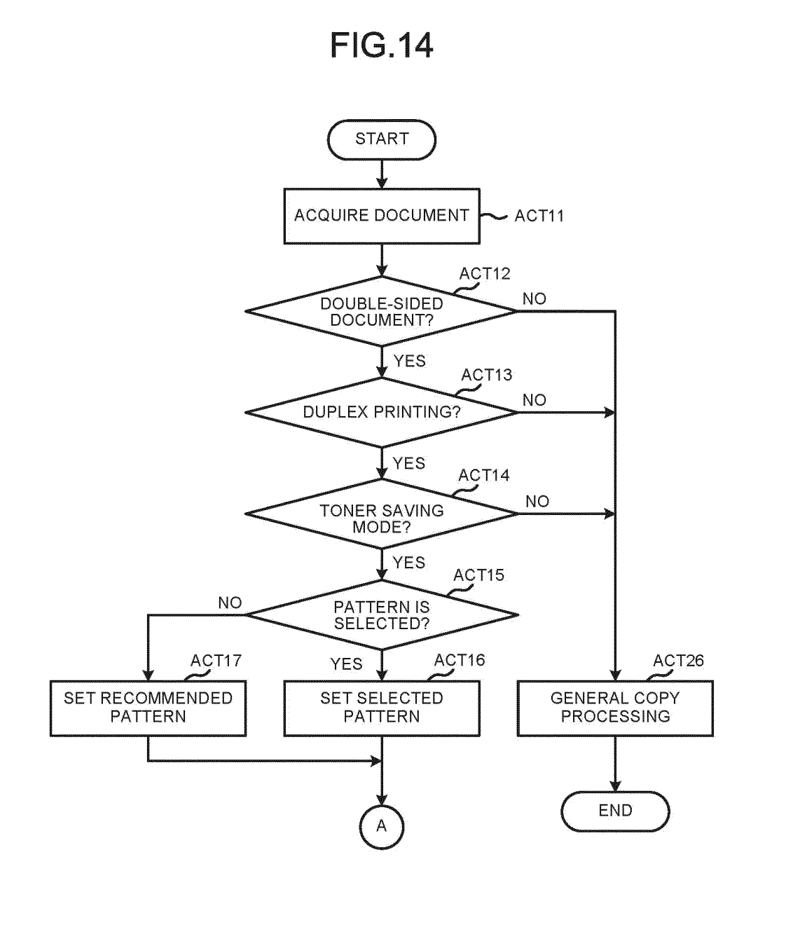

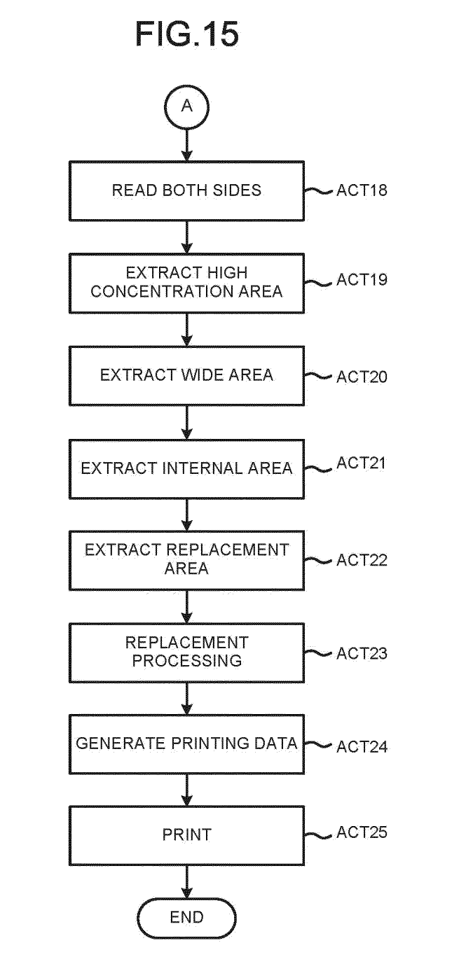

FIG. 14 and FIG. 15 are flowcharts illustrating an example of the operations of the digital multi-functional peripheral 10.

Herein, it is assumed that the user of the digital multi-functional peripheral 10 desires to copy the document. Further, it is assumed that the user of the digital multi-functional peripheral 10 sets the document in the scanner 1.

First, the scanner 1 acquires the document (ACT 11). After the scanner 1 acquires the document, the scanner CPU 11 determines whether or not the document is a double-sided document which is printed on both sides thereof through the scanner 1 (ACT 12).

If the scanner CPU 11 determines that the document is a double-sided document (YES in ACT 12), the system CPU 51 determines whether or not a duplex printing mode for carrying out printing on both sides of the paper is set (ACT 13). If it is determined that the duplex printing mode is set (YES in ACT 13), the system CPU 51 determines whether or not the toner saving mode for saving toner is set (ACT 14).

If it is determined that the toner saving mode is set (YES in ACT 14), the system CPU 51 determines whether or not a pattern selection is received from the user of the digital multi-functional peripheral 10 (ACT 15). For example, the system CPU 51 determines whether or not the user selects a pattern through the touch panel 4b.

If it is determined that the pattern selection is received (YES in ACT 15), the system CPU 51 sets the pattern selected by the user as the pattern to replace the replacement area with (ACT 16).

If it is determined that the pattern selection is not received (NO in ACT 15), the system CPU 51 sets a pre-determined recommended pattern as the pattern to replace the replacement area with (ACT 17).

After the system CPU 51 sets the pattern selected by the user (ACT 16), alternatively, after the system CPU 51 sets the recommended pattern (ACT 17), the scanner CPU 11 reads both sides of the document through the scanner 1 (ACT 18). Herein, one surface of the document is referred to as a document surface a (first surface image) and the other surface of the document is referred to as a document surface b (second surface image).

After the scanner CPU 11 reads the both sides of the document, the image processing section 58 extracts high concentration areas from the document surface a and the document surface b (ACT 19). That is, the image processing section 58 extracts a high concentration area (high concentration area a) from the document surface a and extracts a high concentration area (high concentration area b) from the document surface b. In addition, the number of the high concentration area a and the number of the high concentration area b may be more than one.

After the high concentration areas are extracted from the document surface a and the document surface b, the image processing section 58 extracts wide areas from the document surface a and the document surface b (ACT 20). That is, the image processing section 58 extracts a wide area (wide area a) from the document surface a and extracts a wide area (wide area b) from the document surface b. In addition, the number of the wide area a and the number of the wide area b may be more than one.

After the wide areas are extracted from the document surface a and the document surface b, the image processing section 58 extracts internal areas from the extracted wide areas (ACT 21). That is, the image processing section 58 extracts an internal area (internal area a) from the wide area a and extracts an internal area (internal area b) from the wide area b.

After the internal areas are extracted, the image processing section 58 extracts replacement areas based on the internal areas and the high concentration areas (ACT 22). That is, the image processing section 58 extracts an area where the internal area a overlaps with the high concentration area b as the replacement area (replacement area a) of the document surface a. Further, the image processing section 58 extracts an area where the internal area b overlaps with the high concentration area a as the replacement area (replacement area b) of the document surface b.

After the replacement area is extracted, the image processing section 58 replaces the extracted replacement area with the pattern set in ACT 16 or ACT 17 (ACT 23). That is, the image processing section 58 replaces the replacement area a and the replacement area b with the pattern.

After the replacement areas are replaced with the pattern, the image processing section 58 generates printing data based on the document surfaces where the replacement areas are replaced with the pattern (ACT 24). That is, the image processing section 58 generates printing data (printing data a) based on the document surface a where the replacement area a is replaced with the pattern and generates printing data (printing data b) based on the document surface b where the replacement area b is replaced with the pattern.

After the image processing section 58 generates the printing data, the printer CPU 61 carries out printing on both sides of the paper based on the printing data (ACT 25). That is, the printer CPU 61 carries out printing on one surface of the paper based on the printing data a and carries out printing on the other surface of the paper based on the printing data b.

After printing is carried out on both sides of the paper based on the printing data, the system CPU 51 ends the operations.

If it is determined that the document is not a double-sided document (NO in ACT 12), or if it is determined that the duplex printing mode is not set (NO in ACT 13), alternatively, if it is determined that the toner saving mode is not set (NO in ACT 14), the system CPU 51 carries out general copy processing (ACT 26). After the general copy processing is carried out, the system CPU 51 ends the operations.

In addition, the image processing section 58 may carry out the processing from ACT 19 to ACT 23 every time a given area is read from the document surface.

Further, the image processing section 58 may also extract the high concentration area based on the concentration of pixels in consideration of the printing concentration designated by the user.

The operations described above may also be controlled and executed by the printer CPU 61.

The image forming apparatus with the constitution described above can replace the replacement area the back surface of which is a high concentration area with a given pattern and then print, the document. As a result, print-through of the back surface occurs in the area replaced with the pattern and the visibility of the area replaced with the pattern is less likely to lower. Further, the image forming apparatus can save the printing material such as the toner and the like by replacing the replacement area with a pattern. Therefore, the image forming apparatus can save the printing material without reducing the visibility.

### A Second Embodiment

Next, a digital multi-functional peripheral 10 according to the second embodiment is described.

The digital multi-functional peripheral 10 according to the second embodiment is different from the digital multi-functional peripheral 10 according to the first embodiment in a point where the scanner 1 scans the single side of the document. Therefore, the other constitutions are endowed with the same reference marks, and are not described in detail repeatedly.

First, an example of the constitution of the scanner 1 according to the second embodiment is described.

The sensor section 67 can read the single side of the document. For example, the sensor section 67 consists of a CCD line sensor arranged to read the single side of the document. That is, the scanner 1 can read the single side of the document.

The scanner CPU 11 can switch back the document after the single side of the document is read. The scanner CPU 11 can read the other side of the switched-back document using the sensor section 67.

The page memory 56 includes a storage area 56a and the like.

The storage area 56a (storage section) stores the document surface read by the scanner 1. For example, the storage area 56a stores the document surface read by the scanner 1 until the printing is ended. In addition, the storage area 56a may be stored in the RAM 52, NVM 54, HDD 55, RAM 62, or the NVM 64 and the like.

Next, an example of the operations of the digital multi-functional peripheral 10 is described.

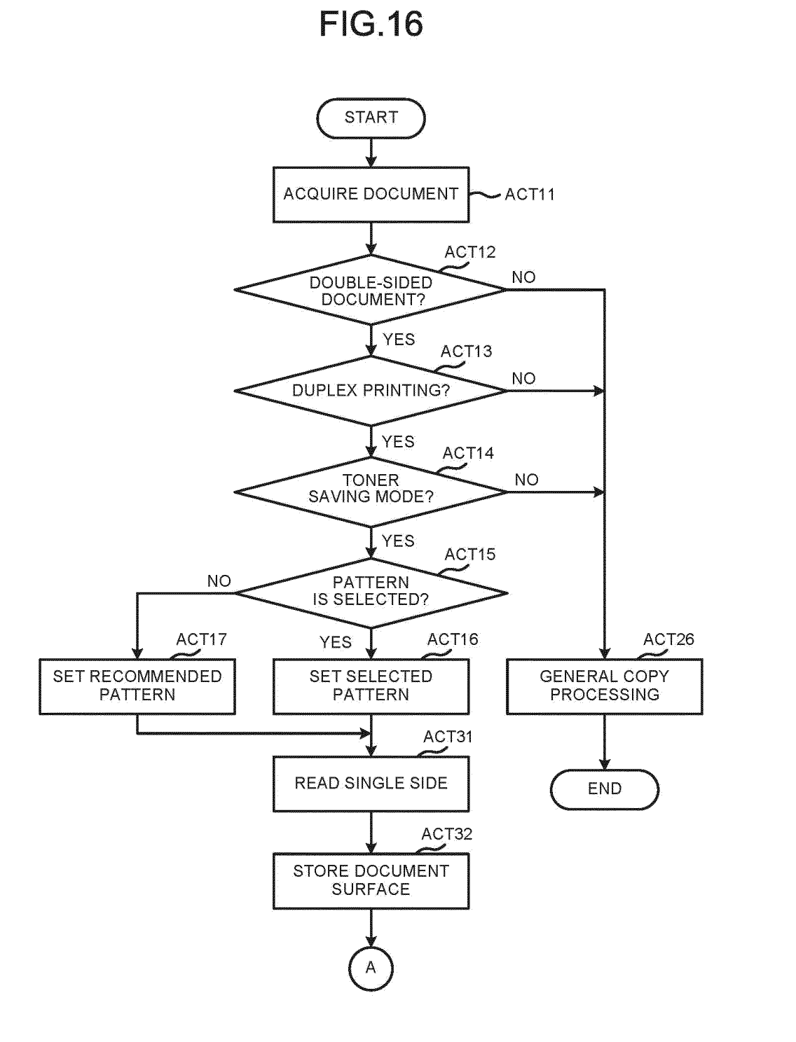

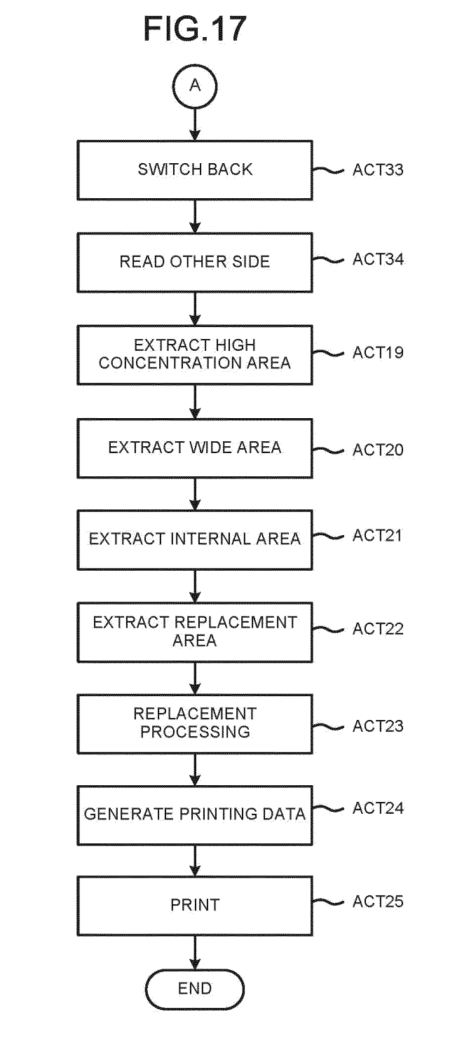

FIG. 16 and FIG. 17 are flowcharts illustrating an example of the operations of the digital multi-functional peripheral 10 according to the second embodiment.

The operations same as those of the digital multi-functional peripheral 10 according to the first embodiment are endowed with the same reference marks and are not described in detail repeatedly.

The processing from ACT 11 to ACT 17 is the same as that described in the first embodiment and is therefore not described repeatedly.

After the system CPU 51 sets the pattern selected by the user (ACT 16), alternatively, after the system CPU 51 sets the recommended pattern (ACT 17), the scanner CPU 11 reads one side of the document as the document surface a through the scanner 1.

After the scanner CPU 11 reads the document surface a, the system CPU 51 stores the data of the read document surface a in the storage area 56a (ACT 32). After the system CPU 51 stores the data of the document surface a in the storage area 56a, the scanner CPU 11 switches back the document (ACT 33). After the document is switched back, the scanner CPU 11 reads the other side of the document as the document surface b through the scanner 1 (ACT 34). That is, the document surface b is the back surface of the document surface a.

After the scanner CPU 11 reads the document surface b, the image processing section 58 extracts the high concentration areas from the document surfaces (ACT 19).

The processing from ACT 19 to ACT 27 is the same as that described in the first embodiment and is therefore not described repeatedly.

In addition, the system CPU 51 may carry out the operations from ACT 15 to ACT 25 even in a case of copying a single side document. In this case, the scanner CPU 11 reads the first document as the document surface a and reads the second document as the document surface b.

After the scanner CPU 11 reads the second document as the document surface b, the image processing section 58 carries out the processing from ACT 19 to ACT 25.

Further, the system CPU 51 may carry out the operations from ACT 15 to ACT 25 even in a case of carrying out duplex printing based on a printing instruction from a PC and the like. In this case, the system CPU 51 receives the first data sent by a PC and the like as the document surface a and receives the second data as the document surface b. after the second data is received as the document surface b, the system CPU 51 carries out the processing from ACT 19 to ACT 25.

In addition, similar to the first embodiment, the operations described above may also be controlled and executed by the printer CPU 61.

The image forming apparatus with the constitution described above can save the printing material without reducing the visibility in a case of reading the document one single side at a time and carrying out copy processing on both sides of the paper. Further, the image forming apparatus can also save the printing material without reducing the visibility in a case of copying a single side document on both sides of the paper, or in a case of carrying out duplex printing based on the printing instruction from a PC.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

1. An image forming apparatus, comprising:
an acquisition section configured to acquire a surface image from a document;
a printing section configured to carry out printing on both sides of paper; and
a control section configured to acquire a first surface image and a second surface image through the acquisition section,
extract a high concentration area from the acquired first surface image,
extract a wide area that printing material is printed from the acquired second surface image,
extract a replacement area that overlaps with the high concentration area from the extracted wide area in a case of respectively printing the first surface image and the second surface image on both sides of the paper,
replace the extracted replacement area with a pattern which consumes less printing material, and
respectively print the acquired first surface image and the second surface image in which the replacement area is replaced with the pattern on the both sides of the paper using the printing section.

2. The image forming apparatus according to claim 1, wherein
the control section extracts an internal area excluding the contour of the wide area from the extracted wide area, and
extracts a replacement area that overlaps with the high concentration area from the extracted internal area in a case of respectively printing the first surface image and the second surface image on both sides of the paper.

3. The image forming apparatus according to claim 1, wherein
the acquisition section simultaneously acquires the front and back surface of the document, and
the control section simultaneously acquires the first surface image and the second surface image respectively from the front and back surface of a double-sided document through the acquisition section.

4. The image forming apparatus according to claim 1, further comprising:
a storage section configured to store the first surface image; wherein
the control section stores, if the first surface image is acquired through the acquisition section, the acquired first surface image in the storage section.

5. The image forming apparatus according to claim 1, further comprising:
an operation section configured to receive an operation of selecting the pattern; wherein
the control section receives the operation of selecting the pattern through the operation section, and
replaces the replacement area with the pattern selected through the operation.

6. The image forming apparatus according to claim 1, wherein
the pattern refers to one of a diagonal line pattern, a horizontal line pattern, a vertical line pattern, a dot pattern or a white blank pattern.

7. An image forming method, including:
acquiring a first surface image and a second surface image;
extracting a high concentration area from the acquired first surface image;
extracting a wide area that printing material is printed from the acquired second surface image;
extracting a replacement area that overlaps with the high concentration area from the extracted wide area in a case of respectively printing the first surface image and the second surface image on both sides of paper;
replacing the extracted replacement area with a pattern which consumes less printing material; and
respectively printing the acquired first surface image and the second surface image in which the replacement area is replaced with the pattern on the both sides of the paper.

8. The image forming method according to claim 7, further including:
extracting an internal area excluding the contour of the wide area from the extracted wide area; wherein
the extraction of the replacement area refers to extracting a replacement area that overlaps with the high concentration area from the extracted internal area in a case of respectively printing the first surface image and the second surface image on both sides of the paper.

9. The image forming method according to claim 7, wherein
the acquisition refers to simultaneously acquiring the first surface image and the second surface image respectively from the front and back surface of a double-sided document.

10. The image forming method according to claim 7, wherein
the acquisition refers to acquiring the first surface image and then acquiring the second surface image after storing the acquired first surface image in a storage section.

11. The image forming method according to claim 7, further including:
receiving an operation of selecting the pattern to replace the replacement area with; wherein
the replacement with the pattern refers to replacing the replacement area with the pattern selected through the received operation.

12. The image forming method according to claim 7, wherein
the pattern refers to one of a diagonal line pattern, a horizontal line pattern, a vertical line pattern, a dot pattern or a white blank pattern.
